(19) United States
(12) Patent Application Publication
(10) Pub. No.: US 2004/0086648 A1
(43) Pub. Date: May 6, 2004

(54) Hydrothermal deposition of thin and adherent metal oxide coatings for high temperature corrosion protection

(76) Inventors: Xiangyang Zhou, State College, PA (US); Zhuang Fei Zhou, State College, PA (US); Serguei N. Lvov, Bellefonte, PA (US); Digby D. MacDonald, State College, PA (US)

Correspondence Address: Paul K. Tomita, Esq., DERGOSITS & NOAH LLP, Suite 1450, Four Embarcadero Center, San Francisco, CA, 94111, US

(21) Appl. No.: 10/460,609

(22) Filed: Jun. 11, 2003

Related U.S. Application Data
(60) Provisional application No. 60/422,745, filed on Oct. 30, 2002.

(51) Int. Cl. B05D 3/02; B05C 3/00; B05C 11/00

(52) U.S. Cl. 427/376.2; 118/663; 118/665; 118/400

(57) ABSTRACT

A metal oxide layer can be deposited onto metallic or ceramic surfaces of a structure in situ, by exposing the surfaces to a precursor solution at an elevated temperature. The precursor solution contains: an organometallic, an oxidant, a surfactant, a chelating agent and water. The precursor solution is injected into the structure and maintained at a specific temperature, pH level and pressure for a predetermined period of time. The resulting in situ metal oxide layer is permanently bonded to the surface structure and does require post deposition heat treatment.

This application claims priority to pending U.S. Patent Application No. 60/422,745 filed Oct. 30, 2002 titled “Hydrothermal Deposition of Thin and Adherent Metal Oxide Coatings for High Temperature Corrosion Protection” which is hereby incorporated by reference.

### BACKGROUND

A boiling water reactor (BWR) is a steam generating system consisting of a nuclear core, an internal structure contained within a pressure vessel, and associated systems. Heat produced in the reactor core boils the water, producing steam that is used to drive turbine generators, which produce electrical energy.

A problem associated with BWR systems is that many of the metal components are exposed to high temperature and high pressure fluids that can cause electrochemical corrosion and intergranular stress corrosion cracking (IGSCC). IGSCC can result in failure of key metal components, so the development of countermeasures to mitigate IGSCC are desirable. Electrochemical corrosion is caused by electrons flowing from anode areas to cathode areas of the BWR. IGSCC of the metal components is due to exposure to oxidizing molecules in the fluid flowing through the BWR system. In particular, water used to cool a reactor core suffers radiolysis, leading to decomposition of some of the water molecules into oxidizing and reducing radicals.

The electrochemical corrosion potential (ECP) is a measure of the oxidation/reduction (REDOX) reactions that occur on the exposed metal surfaces of the BWR. The REDOX reactions are dependent upon the concentrations of dissolved O₂, H₂ and H₂O₂ in the water. The ECP is reduced by lowering the exchange current densities for the reduction of oxygen and hydrogen peroxide. The ECP is also reduced by increasing the exchange current density for the oxidation of hydrogen. ECP probes are available to monitor the ECP levels in a BWR system. The ECP level is related to the IGSCC of the metal components. Specifically, IGSCC is accelerated when the ECP is above the “critical value” of −230 mV measured on the standard hydrogen electrode scale. In contrast, when the ECP is below this critical value the IGSCC of the metal components is negligible.

One example of a large structure that is subject to corrosion degradation and IGSCC is the core internals of a BWR in a commercial nuclear power plant. In boiling water reactor, radiolysis generates a large amount of oxidants, mainly O₂ and H₂O₂. These oxidants are dissolved in the cooling water and cause the electrochemical potential (ECP) of stainless steel and Ni-based alloy tubes, pipes, and vessels to rise to a level at which IGSCC can occur.

Also, neutron activation in the reactor core generates radioactive species, such as Co-60 and N-16. The radioactive Co-60 species can be absorbed into the surface of the oxide films, such as spinel oxides, that form on stainless steel and Ni-based alloys (e.g. Alloy 600), thereby increasing the radioactivity of these components. The increased radioactivity of the components may result in an undesirable increase in radiation exposure of reactor personnel.

It is desirable to minimize corrosion and IGSCC by keeping the ECP below the critical value in BWR systems. There are several known methods for reducing the ECP. The ECP can be reduced by adding high levels of hydrogen to the feed water flowing through the BWR system. The hydrogen combines with the oxidants in the water on the surfaces of stainless steels and Ni-based alloys that the water contacts. The reaction of the hydrogen with the oxidants prevents the oxidants from reacting with exposed metal components and raising the ECP. A problem with hydrogen injection systems is that they are expensive to install and increase the radiation build-up on ex-core reactor components. Another problem with hydrogen injection systems is that not all BWR system components are protected from IGSCC.

A method for improving the effectiveness of hydrogen injection is to deposit a layer of a noble metal such as Pt and Pd onto the exposed surfaces. The noble metals act as a catalytic material that increases the reactions between oxidants and the injected hydrogen. The noble metal improves the efficiency, so that the amount of hydrogen needed to lower the ECP below the critical potential is reduced. Although the noble metal coating (NMC) or doping technology improves the hydrogen efficiency, hydrogen injection is still required.

Another method for reducing the ECP is by depositing a dielectric coating, such as ZrO₂, on the metallic components in BWR systems. Insulating coatings lower the ECP and inhibit IGSCC in high temperature BWR applications without the need for injecting hydrogen into the feed water. The dielectric layer inhibits charge transfer from the exposed surfaces of a BWR. The reduction in charge transfer reduces the exchange current densities of the REDOX reactions that produce oxidizing species. By minimizing the REDOX reactions, the ECP level is also reduced. Again, if the ECP is maintained below the critical level, IGSCC is minimized.

There are many known methods for forming dielectric metal oxide coatings including: chemical vapor deposition (CVD), physical vapor deposition (PVD), thermal spray, ion sputtering, sol-gel, electrophoretic deposition, electrochemical deposition, etc. Many of these metal oxide deposition methods require complex machinery that is not easily adaptable for depositing coatings on complex and intricate shaped BWR components. It is prohibitively difficult to deposit metal oxides onto many BWR components of the massive size and complex geometry such as the internal surfaces of tubes and pipes, using known methods.

### SUMMARY OF THE INVENTION

The present invention is an in situ method for forming a thin, dense, adherent metal oxide coating on metallic surfaces that can lower the ECP to values below which IGSCC is observed in BWR systems. The metal oxide layer is deposited by injecting a liquid precursor into a structure and heating the precursor. The metal oxide is deposited onto areas of the structure that are in contact with the precursor and are heated to a temperature of about 170° C. The inventive metal oxide coating method is particularly useful in depositing metal oxides on the internal surfaces of tubes, pipes, and vessels that have been assembled into a complex structure such as a BWR system.

In an embodiment, a layer of zirconium oxide is deposited onto the interior stainless steel surfaces of a BWR system. The liquid precursors are stored and injected into the structure from two pressure vessels. A first pressure vessel containing an organometallic compound and a second pressure vessel containing a mixed solution are connected to the BWR system with appropriate valves, piping, and instrumentation. The organometallic compound may include Zr-n-propoxide and 1-propanol. The mixed solution may include: an oxidant, a surfactant, a chelating agent and water. The organometallic and mixed solution are injected into the structure to be protected against IGSCC from the two pressure vessels by opening valves so the fluids flow into the structure. By filling the structure, the liquid precursor comes into contact with all exposed interior surfaces depositing a layer of ZrO₂. The temperature of the structure and fluids are maintained at an elevated temperature by heaters. The injected liquid precursor flows through the structure and out through a pressure relief valve that controls the internal pressure of the structure.

The bonding of the ZrO₂ is achieved through chemical reaction with the structure material. The oxidant in the precursor solution oxidizes the surfaces of the structure. In a steel structure the oxide causes an iron oxide film to be formed on the exposed surfaces. The oxidant also reacts with the exposed base steel producing Fe²⁺ and Fe³⁺ cations. These cations combine with hydroxyl ion in the precursor to form Fe(OH)₂ and Fe(OH)₃. An interface bond is formed between the ZrO₂ and the iron oxide film on the exposed stainless steel surfaces.

Various deposition processing conditions are maintained by a control system so that the deposited ZrO₂ layer is non-porous, dense, of uniform thickness, and is securely bonded to the exposed surfaces. The deposition conditions are monitored by pressure transducers, thermocouples, oxygen probes, reference electrodes and pH probes. Based upon the feedback from the sensors a control system can make various adjustments to the system components. For example, during deposition the pressure can be controlled by adjusting the relief valve, the flow valves and pump pressure. The precursor temperature can be controlled by adjusting the electrical power to the heaters. The precursor chemical mixture can be adjusted by controlling the injection flow of the precursor components. The pH level is controlled by titration of the precursor by the control system.

In particular, the deposition of the metal oxide layer onto a steel surface is affected by the pH level of the precursor solution and the surface charge density of the structure. For a strong interface bond, the target surface and the zirconia particles need to have opposite charges. The surface charge density is influenced by the pH of the precursor fluid. At low pH the zirconia particles may be more positively charged and at a higher pH the surface is more negatively charged. In the preferred embodiment, the surface charge density is zero and the pH level is about 5.5 to 7.0. When the pH is within this range, the structure surface and the particles are oppositely charged and an interface bond is formed during metal oxide deposition. If the pH level is outside of this range, the surface and particles have the same charge and metal oxide deposition does not occur.

The inventive process has identified the critical factors that must be controlled (i.e., the precursor solution chemistry and deposition parameters such as temperature, solution pH, and flow rates) to be able to deposit zirconium oxide films with the desired attributes. It is an improvement over prior art methods of depositing metal oxides because the deposition can be performed in situ. Many metal oxide deposition systems require special equipment and cannot uniformly deposit the metal oxide on large or complex-shaped surfaces. Some known metal oxide deposition processes such as sol-gel, electrophoretic, and electroless plating technologies require post-deposition heat treatment such as drying and calcinations. These post deposition heat treatment procedures are impractical when applied to the large and complex structures found in a BWR. The inventive metal oxide deposition process is an improvement over these deposition methods because post deposition heat treatment is not required, simplifying the deposition process.

### BRIEF DESCRIPTION OF THE DRAWINGS

The invention is herein described, by way of example only, with reference to embodiments of the present invention illustrated in the accompanying drawings, wherein:

FIG. 1 is a drawing of an embodiment of one metal oxide deposition system;

FIG. 2 is a drawing of an embodiment of a second metal oxide deposition system;

FIG. 3 is a graph illustrating the relationship between the surface charge density and the pH level of the precursor solution for depositing the metal oxide;

FIG. 4 is a drawing of the chemical reaction that bonds the metal oxide to an exposed steel surface;

FIG. 5 is a drawing of the molecular bond of the metal oxide to an exposed steel surface; and

FIG. 6 is a drawing of graph illustrating the change in ECP during the metal oxide deposition process.

### DETAILED DESCRIPTION

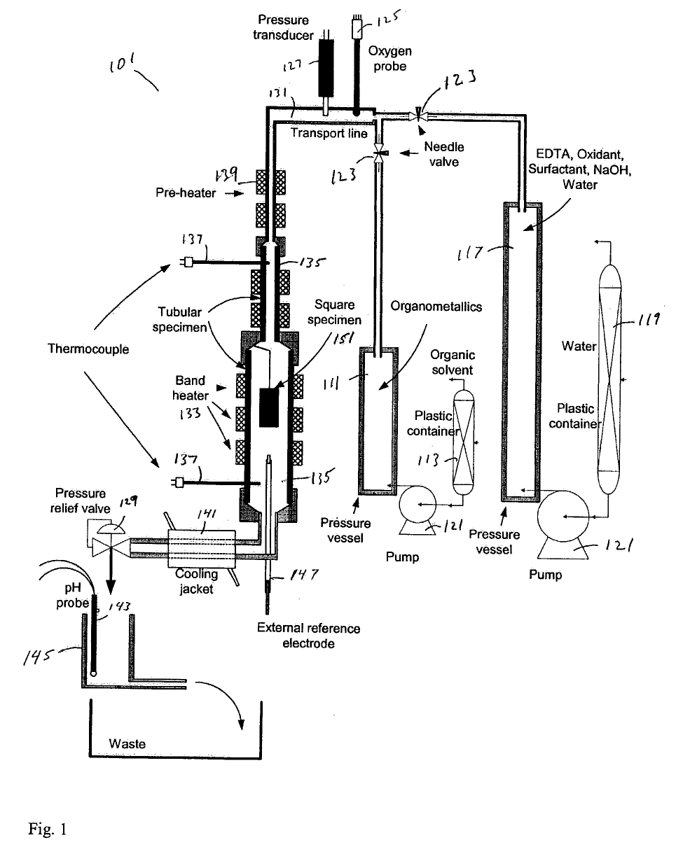

An embodiment of the inventive system will be described with reference to FIG. 1. The exemplary structure is a water loop 101 which may be an industrial component that is subject to a large temperature gradient across the wall thickness. This type of structure includes the fuel rod cladding in nuclear power plant and pipes in the heating furnaces of refineries.

An organometallic compound is contained in a first pressure vessel 111 and an organic solvent is stored in a first container 113. A pump 121 pumps the organic solvent into the first pressure vessel 111 and pressurizes the first pressure vessel 111. A second pressure vessel 117 stores a mixed solution that includes a chelating agent, an oxidant, a surfactant, and water. Pure water contained in a second container 119 is pumped through pump 121 to the second pressure vessel 117 pressurizing the second pressure vessel 117. Valves 123 are used to control the flow of fluids from the first pressure vessel 111 and the second pressure vessel 117 into the structure 151 upon which a metal oxide layer is to be deposited. The organometallic compound and mixed solution are pumped into the transport line 131 where they are mixed to form a precursor. The pumps 121 and valves 123 control the pressure within the first pressure vessel 111 and the second pressure vessel 117.

The precursor may be heated with pre-heaters 139 before flowing into the structure 135. The precursor then flows into the structure 135 to deposit the metal oxide layer via a series of physical and chemical processes. While in the main structure 135 the precursor is heated by band heaters 133 mounted around the structure 135. The metal oxide layer is deposited on surfaces in the structure 135 which contact the precursor fluids and where the proper deposition temperature can be maintained. The metal oxide is deposited on the interior surfaces of the structure 135 as well as upon any objects 151 within the structure 135 that are exposed to the heated precursor.

During the metal oxide deposition process, parameters including temperature, pressure and pH level are monitored by proper probes and controllers (not shown). The controllers maintain the optimum metal oxide deposition conditions. The temperature of the precursor is monitored with thermocouples 137. If the monitored temperature falls outside the optimum range, the temperature controller adjusts power to the band heaters 133 to correct the temperature of the structure 135 and precursor. Specifically, power to the band heaters 133 is increased if the monitored temperature is too low and power is decreased if the monitored temperature is too high.

A pressure transducer 127 monitors the internal pressure of the structure 135 and a pressure relief valve 129. The relief valve 129 is set to prevent the internal pressure from exceeding a predetermined set pressure. If the internal pressure exceeds the set pressure, the relief valve 129 increases the precursor flow rate out of the structure 135. The controller may also reduce the flow of the precursor components into the structure 135. Conversely, if the internal pressure drops below the desired level, the relief valve 129 reduces the precursor flow rate out of the structure. The controller may also increase the flow of precursor into the structure 135 by opening the valves 123 or increase the output of the pumps 121.

The dissolved oxygen level in the transport line is monitored with an oxygen probe 125. In a BWR system that does not have an insulative layer, the ECP of the structure increases with the oxygen level. The ECP is monitored using the external reference electrode 147. The ECP level is indicative of the corrosion potential and the susceptibility to IGSCC. As discussed, when the ECP is below about −230 mV, the IGSCC is negligible. By monitoring the ECP level, the effectiveness of the metal oxide layer can be determined. Before the metal oxide deposition process, the ECP level may be well above −230 mV. As the metal oxide is deposited the ECP level drops below −400 mV, effectively mitigating IGSCC, regardless of the oxygen level.

The used precursor passes through a cooling jacket 141 to reduce the temperature of the fluid and exits the structure 135 through a pressure relief valve 129. The used precursor flows into a temporary holding tank 145 where the pH value is measured with a pH probe 143. The controller detects the pH level and may adjust by titration the mixture of the precursor components to correct the pH error. The controller may tritrate the precursor by controlling the flow of precursor components into the structure 135. The controller adjusts the valves 123 if necessary to the correct the pH level of the precursor.

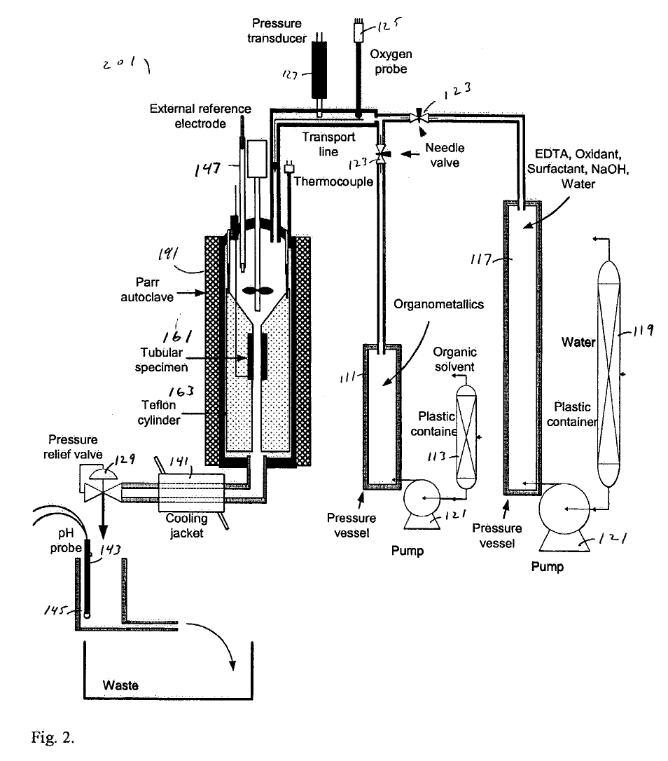

FIG. 2 illustrates a structure that is subject to a small temperature gradient across the wall thickness, illustrative of applications such as thermally insulated pipes and tubes in the cooling circuits of nuclear power plants. The structure is similar to the water loop illustrated in FIG. 1 but utilizes an autoclave 191 to heat the fluid rather than pre-heaters and band heaters. The components having like reference numbers function in the same manner described with reference to FIG. 1. In FIG. 2, a tubular specimen 161 and a Teflon cylinder 163 are placed within the autoclave 191. The Teflon cylinder 163 covers the outer surfaces of the specimen 161. Only the interior surfaces of the specimen 161 are exposed to the heated precursor and coated with a metal oxide layer. The metal oxide will not adhere to the Teflon cylinder 163. Various other system configurations that allow the precursor solution mixture, the internal temperature and pressure and pH to be controlled are within the scope of this patent.

The metal oxide layer is deposited onto metal or ceramic surfaces through a series of chemical reactions between the target structure and the precursor solution. The following disclosure is directed to the chemical reactions an embodiment of the inventive process used to deposit a zirconium oxide layer on a steel surface. The composition of the precursor comprises: zirconium isopropoxide-organometallic, 1-propanol-organic solvent, ZrO(ClO₄)₂-oxidant, C₁₂H₂₅O₄SNa (SDS)-surfactant, ethylenediaminetetraacetic acid (EDTA)-chelating agent, NaOH and water. The zirconium oxide deposition reactions include: hydrolysis of the organometallics, suspended particle size reduction, absorption of suspended particles into the surface and interface bond formation.

The hydrolysis of zirconium isopropoxide is represented by the equation nZr(OR)₄+4nH₂O=nZr(OH)₄+4nROH. Where the term “R” refers to any organic chain. Hydrolysis of the zirconium isopropoxide yields the suspended zirconia particles. If the hydrolysis rate is too fast and a large amount of organometallics are hydrolyzed in a short period of time, the zirconia particles can grow into undesired aggregates. The rate of hydrolysis is regulated by controlling the ratio of the injection rates of water into the mixed solution pressure chamber and organic solvent into the organometallic pressure chamber. Higher concentrations of water and organic solvent slow the rate of hydrolysis.

The size of the suspended zirconium particles in the precursor is another factor that affects the zirconium oxide layer deposition. Minimizing the particle size enhances the stability of the suspensions and allows the suspended particles to flow with the precursor to the desired deposition locations. Small particles also produce denser zirconium oxide layers that are securely bonded to the target structure. Large particles can produce loose coatings that are poorly bonded.

The size of the suspended zirconia particles is affected by the absorption of suspended particles in the EDTA chelating agent. At elevated temperatures (>100° C.), EDTA will complex with the suspended particle. Complexing with the EDTA results in smaller particles by partly dissolving the larger particles. For optimum zirconium oxide deposition, it is desirable to produce particle as small as possible or preferentially below 200 nm while avoiding complete dissolution of these particles. It is desirable not to completely dissolve the particles in the EDTA because particles are necessary for depositing a metal oxide coating. The particle dissolving process is controlled by adjusting the pH, flow rate, or residence time. The complexing reaction of the zirconia particles is

Zr(OH)₄+H₄ EDTA=Zr−H₂EDTA²⁺+2O H⁻+2H₂O.

The adhesion of the zirconium oxide layer to the steel structure is affected by the adsorption level of the suspended particles to the structure surfaces to be coated. The adsorption of the suspended particles on a metal surface is caused by variations in the surface charges of the structure. The surface charges are affected by protonation and ionization of the surface hydroxide groups. In these processes —OH₂⁺ or —O⁻ entities can be formed on the exposed metal surfaces depending on the pH of the precursor.

At a low pH level more H⁺ ions exist in the precursor and the following reaction occurs.

(M-OH)_{surfacr}⁰+Hₛₒₗᵤₜᵢₒₙ⁺=(M-OH₂)_{surface}⁺

At a higher pH level more OH⁻ ions exist and the following reaction occurs.

(M-OH)_{surface}⁰+OHₛₒₗᵤₜᵢₒₙ⁻=(M-O)_{surface}⁻+H₂O

In the chemical equations, (M-OH)_{surface}⁰, (M-OH₂)_{surface}⁺ and (M-O)_{surface}⁻ are the surface groups of the oxide film or suspended oxide particles. The surface groups are part of an acid and base equilibria. Because each reaction site occupies a specific area there are a fixed number of reaction sites per unit area of the exposed surface.

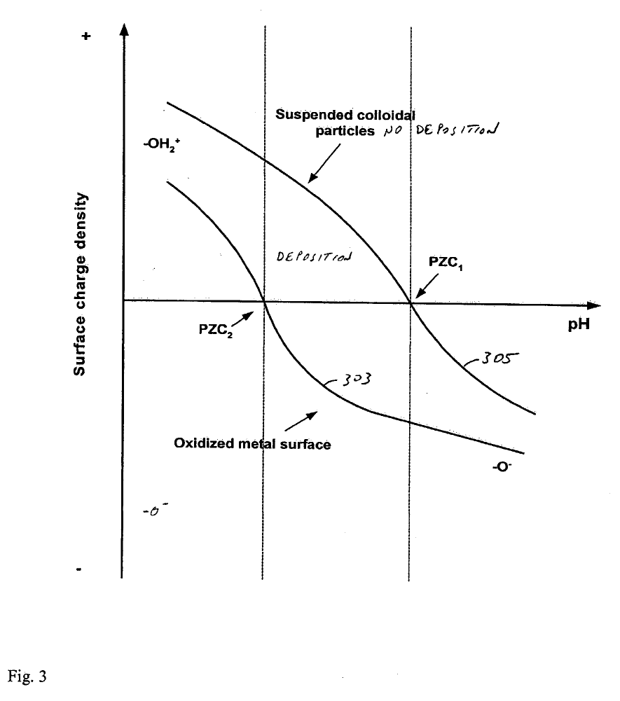

FIG. 3 graphically illustrates the relationship between surface charge density and pH level. The horizontal axis corresponds to a surface charge equal to zero. The region above the horizontal axis is representative of the condition where there are more of the (M-OH₂)_{surface}⁺ and the region below the axis is representative of the condition where there are more of the (M-O)_{surface}⁻. When the surface charge (zeta potential) is zero there is an equal population of (M-OH₂)_{surface}⁺ and (M-O)_{surface}⁻ groups. When the surface charge is zero, the condition is known as isoelectric point (IEP) or “pH of zero charge” (PZC).

The film deposition system consists of an oxidized stainless steel surface that is covered by a pre-existing film comprising metal oxides such as Fe₂O₃, Cr₂O₃, and NiO, suspended ZrO₂ particles, and the solution. Thus, according to the above analysis, the surface charge density (and zeta potential) of both the oxidized stainless steel surface and ZrO₂ particles are functions of pH of the solution. As an example with reference to FIG. 3, the curved lines 303 and 305 respectively represent, surface charge of the oxidized stainless surface and the suspended ZrO₂ particles over a range of precursor solution pH values.

The horizontal axis represents the condition of surface charge density=0. For proper deposition, the surface charge (zeta potential) of the suspended ZrO₂ particles must be the opposite of target oxidized stainless steel surface. For a range of pH values between PZC₁ (Point of Zero Charge) 301 and PZC₂ 302, the surface charge of the suspended ZrO₂ particles are positive and the surface charge of the target oxidized stainless steel surface is negative. For example, if the precursor solution is pH₁ 311 which is between PZC₁ 301 and PZC₂ 302, the surface charge of the suspended particles is positive as indicated by point 321 and the surface charge of the oxidized stainless steel surface is negative as indicated by point 322. At pH₁ 311 the suspended particles and the target stainless surface are oppositely charged and attracted to each other facilitating proper ZrO₂ deposition. During in-situ deposition, the pH level of the precursor solution is titrated to obtain a precursor pH level between the PZC₁ 301 and PZC₂ 302.

When the precursor solution pH is not between PZC₁ 301 and PZC₂ 302, ZrO₂ deposition does not occur because the ZrO₂ particles and the target surface have the same surface charge. For example, at pH₂ 312 which is lower than PZC₂ 302, the suspended metal oxide particles are deposited not because the surface charge of the target surface 324 and the surface charge of the ZrO₂ particles 323 are both positively charged. Similarly, deposition does not occur at pH₃ 313 which is a higher pH than PZC₁ 301 because both the surface charge of the target surface 306 and the surface charge of the ZrO₂ particles 325 are negatively charged.

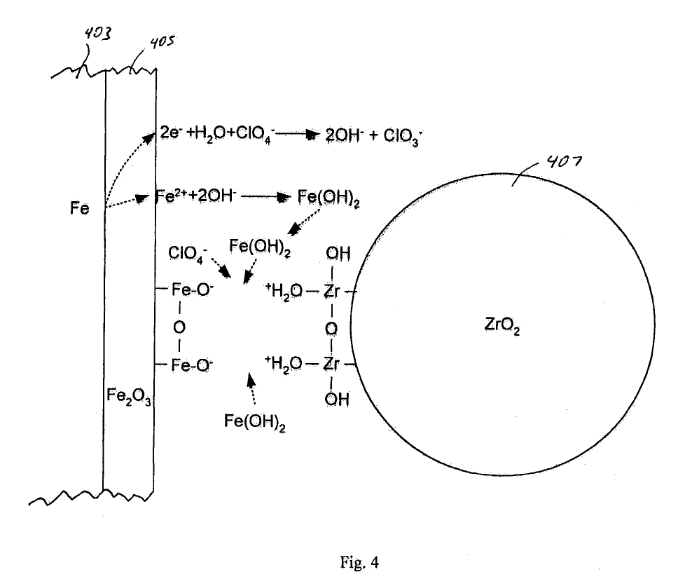

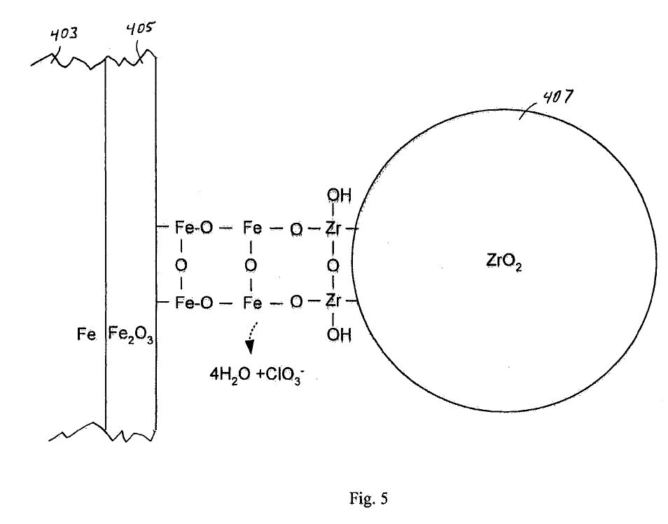

During metal oxide deposition, an interface bond is formed between the deposited metal oxide and the exposed surface. The interface bond of the metal oxide coatings is produced by chemical reactions of the precursor oxidant ZrO(ClO₄)₂. The oxidant oxidizes the target surface and forms covalent bonds at the interfaces of the structure surface and the zirconium oxide. FIGS. 4 and 5 illustrate the chemical reactions that occur for bonding of the metal oxide to the exposed metal formation process. The target surface 403 represents a solid steel surface having an iron oxide layer 405.

With reference to FIG. 4, the oxidant ZrO(ClO₄)₂ promotes two chemical reactions to bond a layer of ZrO₂ to stainless steel. The first reaction is the dissolution of steel 403, which produces Fe²⁺ or Fe³⁺ cations at the interface between the steel 403 and the iron oxide film 405. The cations diffuse into water and combine with hydroxyl ions to form Fe(OH)₂ or Fe(OH)₃. The electrons that are released from the dissolution reaction are consumed by the cathodic reaction 2e⁻+H₂O+ClO₄⁻=2OH⁻+ClO₃⁻. The iron ions and hydroxyl ion undergo a further reaction, Fe²⁺+2OH⁻=Fe(OH)₂.

The second oxidant reaction bonds the ZrO₂ molecules 407 to the existing iron oxide film 405. The ClO₄— and Fe(OH)₂ are consumed by the interface bond between the iron oxide and ZrO₂. The interface bond reaction produces water and ClO₃⁻. The reaction can occur at the interfaces between the target stainless steel surface and the ZrO₂ particles that are attracted and absorbed by the target surface and at the interfaces between the ZrO₂ particles if the particles are close (a few micrometers) to the target surface. In both situation Fe(OH)₂ can diffuse into the interfaces to form the interface bonds. If, however, the particles are too far from the target stainless surface, the bond reaction cannot occur due to lack of Fe(OH)₂. The bond reaction is accelerated at higher temperatures due to fast diffusion and fast reaction kinetics. However, a temperature higher than 220° C. results in other problems such as severer corrosion and decomposition of EDTA. The decomposition of EDTA dramatically changes the chemistry and pH of the solution so that the condition for deposition will on longer exist.

FIG. 5 illustrates the molecular interface bond between the ZrO₂ particles 407 and the iron oxide film 405 caused by the second oxidant reaction. The second oxidant reaction produces H₂O and ClO₃⁻. The interface bond produces a zirconium oxide layer which has a strong interface bond to the iron oxide layer 405 and the target steel 403 surface. The interface bond is superior to a weak electrostatic attractive force and/or hydrogen bond, which produces a loose and porous metal oxide layer on the exposed surface 403.

The preferred chemical composition and processing conditions for the inventive hydrothermal for depositing ZrO₂ on exposed surfaces of Type 304 stainless steel tubes were determined by experimentation. The experimental results are disclosed as follows. As discussed with reference to FIG. 1, the deposition system includes a first pressure vessel 111 which stores an organometallic compound, a first plastic container 113 which stores an organic solvent, a second pressure vessel 117 containing a mixed solution and a second container 119 containing water. In the experiment, the organometallic stored in the first pressure vessel 111 was Zr-n-propoxide (70%) 100 ml and 1-propanol 110 ml. The organic solvent stored in the container 113 was 1-propanol 110 ml. The mixed solution in the second pressure vessel 117 was: EDTA 70 g, ZrO(ClO₄)₂ 10 g, C₁₂H₂₅O₄SNa (SDS) 1.0 g, NaOH 24 g and water 750 ml. The second container 119 stored pure water. The precursor components are injected into the transport line 131 where they are mixed and then flow through the interior surfaces of the stainless steel tube 135. The pH level of the mixed solution in the second pressure vessel is 5.6.

In this experiment, specific deposition conditions were maintained. The organic solvent, 1-propanol, was injected at a rate of 1.5 ml/min. The water injection rate from the second container into the second pressure vessel 117 was 15 ml/min. The temperature of the deposition solution was maintained between 170-200° C. The fluid pressure during the zirconium oxide deposition was about 500 psi to 1,500 psi. The oxygen concentration measured by the oxygen probe 125 was maintained between 3 to 10 ppm. The pH of the waste solution measured at the outlet by the pH probe 143 was 5.5 to 7.0. The interior surfaces of the tubes were exposed to the heated precursor fluids for 10 hours.

At the end of the experimental deposition processes, uniform zirconium oxide coatings were produced on the exposed surfaces on of the tubular specimens. The coating was 1-4 μm thick, free of pores, and well bonded to the substrate metal. The test samples were examined with a scanning electron microscope and an electron dispersive spectroscopy (EDS) analysis confirmed that the deposited film contained Zr. X-ray diffraction analysis of the test samples confirmed that the coating was monoclinic ZrO₂. AC impedance spectroscopic analysis indicates that interface resistance of the zirconium oxide coating was about 10⁶ ohm cm². The zirconium oxide coating resistance was substantially higher than the interface resistance of an uncoated stainless steel surface, which is typically about 300 ohm cm².

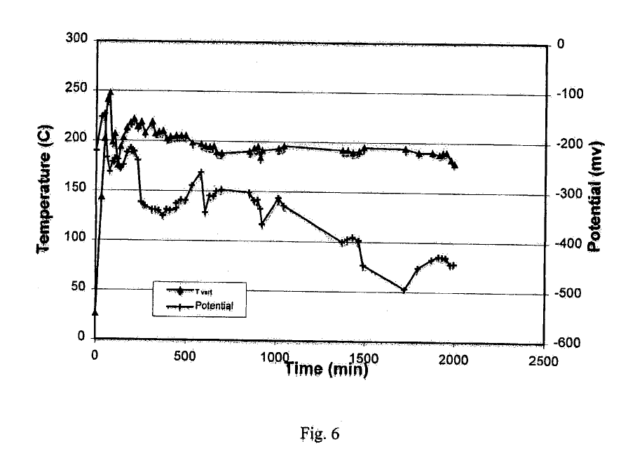

As discussed, the zirconium oxide layer protects the structure from IGSCC when the ECP of the structure is less than −230 mV on the standard hydrogen electrode scale. FIG. 6 shows the record of the process temperature and the ECP of the experimental tube samples during the deposition process. The ECP of the experimental samples with the zirconium oxide deposition decreased from −100 mV to below −400 mV within 35 hours of deposition processing. The reduction of the ECP below −230 mV mitigates the corrosion and IGSCC in Type 304 stainless steel in high temperature water that is common in boiling water reactor applications.

The inventive metal oxide deposition process provides a thin and adherent metal oxide coating that mitigates general corrosion, IGSCC, oxidation, and radiation buildup in hot and low temperature aggressive environments. The inventive process has several advantages over the prior art metal oxide deposition methods. The inventive process does not require complex industrial equipment. The inventive process can be performed by simply pumping precursors into contact with a structure and maintaining the desired temperature and pressure conditions in the structure to be coated. The inventive process utilizes a one-step procedure that does not require post-deposition heat treatment to achieve the desired results. The application temperature of the inventive hydrothermal deposition process is lower than the application temperature of other coating technologies such as CVD, ion sputtering, cladding, and thermal spray. Temperatures in these processes can reach 500° C. and cause undesired structural transformations and thermal stresses in the substrate materials.

In the foregoing, a system for depositing a metal oxide layer on a structure has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for hydrothermally depositing a metal oxide layer in situ, comprising the steps:
injecting a precursor solution comprising: an organometallic, an oxidant, a surfactant, a chelating agent and water into a structure;
heating the precursor solution to a temperature greater than 100° Centigrade;
exposing a portion of the structure to the heated precursor solution; and
depositing a metal oxide layer onto a surface in the structure that is exposed to the precursor solution.

2. The method for hydrothermally depositing the metal oxide layer of claim 1 wherein the metal oxide is zirconium oxide, the organometallic is Zr-n-propoxide and the depositing step comprises forming an iron oxide layer on the surface in the structure and bonding the zirconium oxide to the iron oxide layer.

3. The method for hydrothermally depositing the metal oxide layer of claim 1 further comprising the step:
pressurizing the structure to more than 300 psi during the deposition step.

4. The method for hydrothermally depositing the metal oxide layer of claim 1 further wherein the pressurizing step comprises monitoring the internal pressure of the structure with a pressure transducer and decreasing the internal pressure with a pressure relief valve if the internal pressure exceeds 2,000 psi.

5. The method for hyrothermally depositing the metal oxide layer of claim 1 wherein the heating step comprises monitoring the temperature of the precursor solution with a thermocouple and increasing the power to an electrical heater in thermal communication with the precursor solution if the temperature of the precursor solution is less than 100° Centigrade.

6. The method for hyrothermally depositing the metal oxide layer of claim 5 wherein the heating step comprises monitoring the temperature of the precursor solution with a thermocouple and decreasing the power to the electrical heater if the temperature of the precursor solution is greater than 300° Centigrade.

7. The method for hyrothermally depositing the metal oxide layer of claim 1 wherein the metal oxide deposited is zirconium oxide, the organometallic is Zr-n-propoxide and the depositing step comprises forming an iron oxide layer on the surface in the structure and bonding the zirconium oxide to the iron oxide layer.

8. The method for hyrothermally depositing the metal oxide layer of claim 7 wherein the oxidant is ZrO(ClO₄)₂ and the deposition step comprises a chemical reaction with the oxidant to bond the zirconium oxide to the iron oxide layer.

9. The method for hyrothermally depositing the metal oxide layer of claim 7 wherein the chelating agent is ethylenediaminetetraacetic acid and the injecting step comprises complexing suspended particles in the precursor solution with the chelating agent.

10. The method for hyrothermally depositing the metal oxide layer of claim 7 wherein the surface structure in the surface stainless steel and the depositing step comprises forming an iron oxide layer on the in the structure and bonding the zirconium oxide to the iron oxide.

11. A system for depositing a metal oxide layer, comprising:
a structure;
a precursor solution comprising: an organometallic, a chelating agent, a surfactant, an oxidant and water;
a first pressurized vessel in fluid communication with the structure for injecting the organometallic component of the precursor solution into the structure;
a heater attached to the structure for heating the precursor solution that has been injected into the structure;
a thermocouple for monitoring the temperature of the structure;
a first controller in communication with the thermocouple for controlling the heater and maintaining the precursor solution at a temperature greater than 100° Centigrade within the structure;
a pressure relieve valve in fluid communication with the structure for controlling the flow rate of the precursor solution through of the structure; wherein a layer of metal oxide is deposited on surfaces in the structure which are exposed to the precursor solution at a temperature greater than 100° Centigrade.

12. The system for depositing a metal oxide layer of claim 11 further comprising:
a second pressurized vessel in fluid communication with the structure for injecting the oxidant and the water components of the precursor fluid into the structure.

13. The system for depositing a metal oxide layer of claim 11 wherein the metal oxide layer is zirconium oxide and the organometallic is Zr-n-propoxide.

14. The system for depositing a metal oxide layer of claim 11 wherein the oxidant is ZrO(ClO₄)₂.

15. The system for depositing a metal oxide layer of claim 11 wherein the chelating agent is ethylenediaminetetraacetic acid.

16. The system for depositing a metal oxide layer of claim 11 further comprising:
a pressure transducer for monitoring the internal pressure of the structure; and
a second controller in communication with the pressure transducer which controls the pressure relief valve;
wherein the pressure relief valve decreases the flow rate of the precursor fluid through the structure if the internal pressure is below a predetermined lower level.

17. The system for depositing a metal oxide layer of claim 11 further comprising a pressure transducer for monitoring the internal pressure of the structure; and
a second controller in communication with the pressure transducer which controls the pressure relief valve;
wherein the second controller increases the flow rate of the precursor solution through the pressure relief valve if the internal pressure is exceeds a predetermined upper level.

18. The system for depositing a metal oxide layer of claim 12 further comprising:
a pH probe for measuring the pH level of the precursor solution; and
a third controller in communication with the pH probe, the second pressure vessel;
wherein the third controller adjusts the ratio of the oxidant and the water so solution the pH level of the precursor between about 5.5 and 7.0.

19. The system for depositing a metal oxide layer of claim 11 further comprising:
an oxygen probe for measuring the oxygen level of the precursor solution.

20. The system for depositing a metal oxide layer of claim 11 further comprising:
a reference electrode for measuring the electrochemical corrosion potential of the precursor solution.
